(19) United States
(12) Patent Application Publication
(10) Pub. No.: US 2003/0156822 A1
(43) Pub. Date: Aug. 21, 2003

(54) Method for editing a multi-view stream in an optical disk apparatus

(76) Inventors: Soung Hyun Um, Anyang-si (KR); Kang Soo Seo, Anyang (KR); Byung Jin Kim, Sungnam (KR)

Correspondence Address: BIRCH STEWART KOLASCH & BIRCH, PO BOX 747, FALLS CHURCH, VA, 22040-0747, US

(21) Appl. No.: 10/366,659

(22) Filed: Feb. 14, 2003

(30) Foreign Application Priority Data
Feb. 14, 2002 (KR) 2002-7940

(51) Int. Cl. H04N 9/74; H04N 9/79; H04N 9/87; G11B 27/00; H04N 5/93; G09G 5/00

(52) U.S. Cl. 386/52; 345/723; 386/4

(57) ABSTRACT

A method for editing an MPEG 2 transport stream into which a plurality of sub-view streams are multiplexed recorded on a rewritable storage medium. Receiving a request for deleting an interval of a sub-view stream contained in the recorded multi-view stream, the method performs a virtual deletion operation by creating position information about the interval and identification information about the sub-view stream and recording the created information in the management information for the multi-view stream, without actually deleting the data corresponding to the interval requested to be deleted. The method facilitates the deletion and retrieval of an arbitrary interval of a specific sub-view stream.

### BACKGROUND OF THE INVENTION

1 . Field of the Invention

The present invention relates to a method for editing an MPEG 2 transport stream into which a plurality of sub-view streams are multiplexed recorded on a rewritable storage medium.

2. Description of the Related Art

A DVD, which is a high-density and high-capacity optical disk, is widely used for storing high-quality moving picture data or audio data. There are several different types of DVDs such as read-only DVD-ROM, one-time recordable DVD-R, and rewritable DVD-RAM or DVD-RW. The standardization of data recording formats for recording moving picture and audio data on a rewritable DVD such as DVD-RAM and DVD-RW is almost completed.

On the other hand, with the start of HD-TV broadcasts the development of a rewritable higher-capacity optical disk for recording and reproducing HD-TV broadcasts has been completed. The higher-capacity optical disk has a storage capacity of about 23 GB, 5 times as much as the capacity of a DVD. The development of application specifications for commercializing the higher capacity storage medium is under way by relevant consumer electronics manufactures.

An optical disk apparatus capable of receiving HD-TV broadcasts and recording received HD contents on a rewritable higher-capacity optical disk having a capacity of 23 GB comprises a DVR recording system 11, an optical pickup 12, and control unit 13, as shown in FIG. 1.

In HD-TV broadcasts, it is possible to multiplex a plurality of sub-view streams obtained from a plurality of broadcast cameras into a single multi-view stream. As depicted in FIG. 2, the corresponding PES packets of sub-view streams contained in a multi-view stream share a presentation time stamp (PTS) and all the sub-view streams are created using a system time clock (STC); therefore a multi-view stream is also called a STC sequence. FIG. 2 shows an exemplary multi-view stream composed of three sub-view streams.

The optical disk apparatus in FIG. 1 sometimes records an MPEG 2 transport stream into which a plurality of sub-view streams are multiplexed on a rewritable high-capacity storage medium 10. Unfortunately, however, management schemes capable of separately managing each of the sub-view streams contained in a multi-view stream are not available yet.

Consequently, if a user wants to delete an interval of a sub-view stream having specific PTS values, the optical disk apparatus in FIG. 1 deletes the intervals of all the sub-view streams having the PTS values. Therefore, if a user attempts to delete an interval of sub-view stream #1, the corresponding intervals of sub-view stream #2 and sub-view stream #3 are deleted together as depicted in FIG. 3, which is a drawback of the conventional method.

If an interval is deleted in each of the sub-view streams, a discontinuity of STC values occurs in the multi-view stream, and therefore the streams before and after the deleted interval are managed as distinct sequences as shown in FIG. 3.

### SUMMARY OF THE INVENTION

It is an object of the present invention to provide a method capable of separately editing sub-view streams contained in a multi-view stream recorded on a storage medium.

A method for editing a multi-view stream in an optical disk apparatus in accordance with the present invention comprises the steps of: receiving a request for deleting an interval of a sub-view stream contained in a recorded multi-view stream; and creating position information about the interval requested to be deleted and identification information about the sub-view stream and recording the position information and identification information in the management information for the multi-view stream.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a brief block diagram of an optical disk apparatus;

FIG. 2 illustrates an exemplary multi-view stream recorded by the optical disk apparatus;

FIG. 3 illustrates a multi-view stream edited by the conventional method wherein when an interval of a sub-view stream contained in the multi-view stream is deleted the corresponding interval of every sub-view stream contained in the multi-view stream is deleted;

FIGS. 4 and 5 illustrate an exemplary multi-view stream in which an interval of a sub-view stream is virtually deleted by a multi-view stream editing method in an optical disk apparatus in accordance with a first preferred embodiment of the invention and the format of A/V clip management information for implementing the virtual deletion; and

FIGS. 6 and 7 illustrate an exemplary multi-view stream in which an interval of a sub-view stream is virtually deleted by a multi-view stream editing method in an optical disk apparatus in accordance with a second preferred embodiment of the invention and the format of A/V clip management information for implementing the virtual deletion.

### DETAILED DESCRIPTION OF THE PREFFERRED EMBODIMENT

In order that the invention may be fully understood, preferred embodiments thereof will now be described with reference to the accompanying drawings.

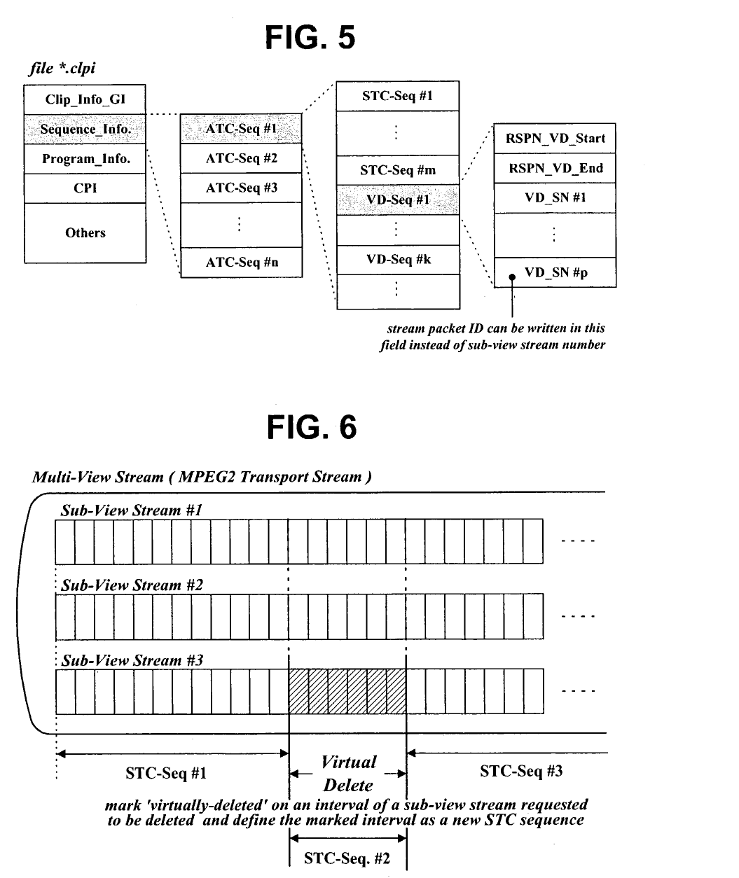

FIGS. 4 and 5 illustrate an exemplary multi-view stream in which an interval of a sub-view stream is virtually deleted by a multi-view stream editing method in an optical disk apparatus in accordance with a first preferred embodiment of the invention and the format of A/V clip management information for implementing the virtual deletion.

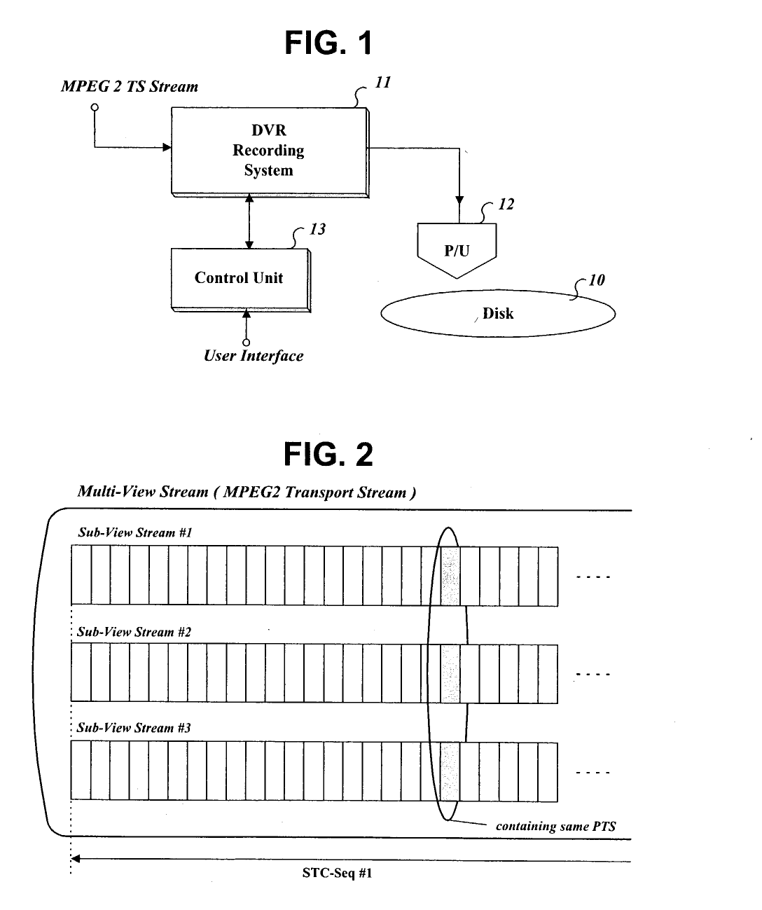

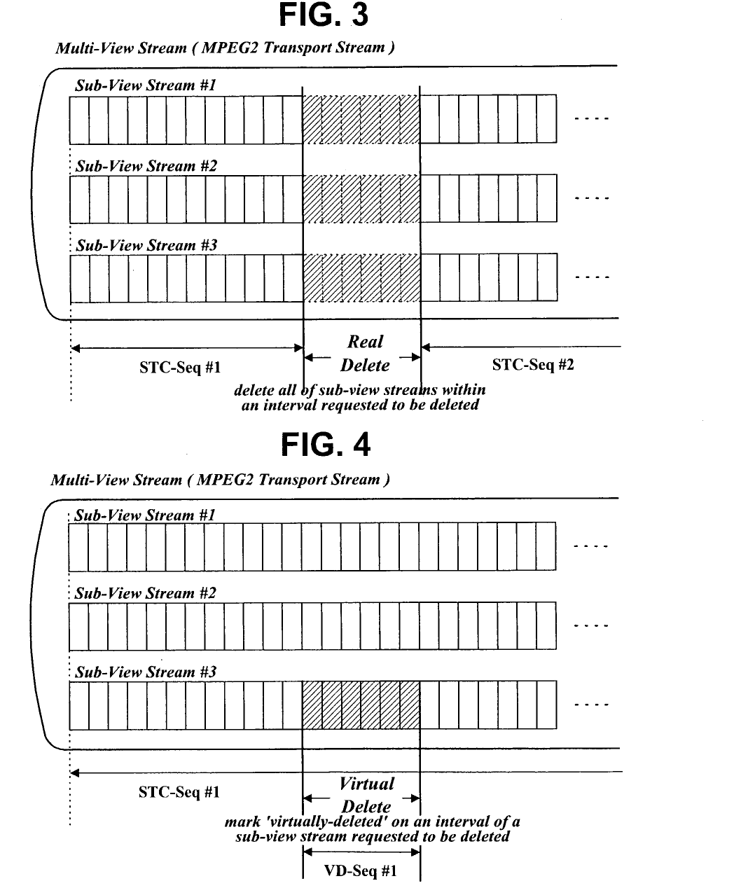

An optical disk apparatus such as an H-DVR comprising the DVR recording system 11, the optical pickup 12, and the control unit 13 as shown in FIG. 1 receives a multi-view stream containing a plurality of sub-view streams, for example 3 sub-view streams, and records the received multi-view stream on the rewritable high-density storage medium 10. The recorded multi-view stream constitutes a single STC-sequence ‘STC-Seq #1’.

Suppose that a user attempts to delete an interval of a sub-view stream contained in the recorded multi-view stream. If the user requests the deletion of an interval of sub-view stream #3 contained in the multi-view stream, the control unit 13 creates information about the interval requested to be deleted and records the created information in the A/V clip management information through the DVR recording system 11, without actually deleting the data corresponding to the interval of the multi-view stream.

The interval requested to be deleted is defined as a new virtually deleted sequence (VD-sequence) and information about the newly-defined sequence is recorded.

The information about the virtual deleted sequence conforms to the structure of the information about the actually recorded STC sequence as shown in FIG. 5 and contains the start position of the VD-sequence ‘RSPN_VD_Start’ (Relative Source Packet Number VD-Seq. Start), the end position of the VD-sequence ‘RSPN_VD_End’ (Relative Source Packet Number VD-Seq. End), and virtually deleted sub-view stream numbers ‘VD_SN’ (Virtually Deleted Sub-View Stream Number). The VD_SN may have multiple fields because intervals of more than one sub-view stream may be requested to be deleted. Stream packet ID (PID) might be used instead of sub-view stream number.

The clip information file (*.clpi) shown in FIG. 5 comprises general clip information ‘Clip_Info_GI’, sequence information ‘Sequence_Info’, program information ‘Program_Info’, characteristic point information ‘CPI’, and other information fields.

The sequence information ‘Sequence_Info’ field contains information about ATC sequences. An ATC sequence is defined as an interval of a stream having continual arrival time stamp (ATS) values, an ATS value assigned to a transport stream packet.

An ATC sequence information field contains information abut STC sequences ‘STC-Seq #i’ and virtual deleted sequences ‘VD-Seq #i’. The information about the virtual deleted sequences is as explained above.

When reproducing an STC sequence, the optical disk apparatus examines the information about the virtual deleted sequence contained in the clip information file to determine whether the STC sequence includes virtual deleted sequences. If any, the virtual deleted sequences are not reproduced and skipped and the corresponding intervals of other sub-view streams are reproduced normally.

If the user requests retrieval of a virtual deleted sequence, the optical disk apparatus simply deletes the information about the virtual deleted sequence, for example, VD-Seq #1 in FIG. 4.

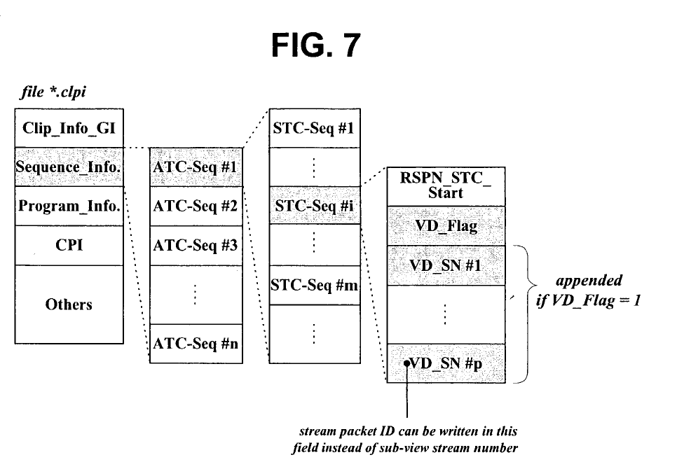

FIGS. 6 and 7 illustrate an exemplary multi-view stream in which an interval of a sub-view stream is virtually deleted by a multi-view stream editing method in an optical disk apparatus in accordance with a second preferred embodiment of the invention and the format of A/V clip management information for implementing the virtual deletion.

In this embodiment, if a user specifies an interval of a sub-view stream contained in a recorded multi-view stream to delete the interval, the control unit 13 divides the multi-view stream into three sequences, sequences before and after the interval requested to be deleted and a sequence corresponding to the interval as shown in FIG. 6, without actually deleting the data corresponding to the interval of the multi-view stream.

Then the control unit 13 modifies the information about the sequence ‘STC-Seq #1’ as the interval of the sequence ‘STC-Seq #1’ has been modified. And the control unit 13 creates information about the newly created sequences ‘STC-Seq #2 and #3’ and records the information in the A/V clip management information. In this case, additional information about each STC sequence is required to indicate whether the STC sequence is virtually deleted.

The structure of the clip information file (*.clpi) in this embodiment is, therefore, as shown in FIG. 7, wherein each STC sequence information has a flag ‘VD_Flag’ indicating whether the STC sequence is virtually deleted as well as the start position of the STC sequence ‘RSPN_STC_Start’.

The VD_Flag set to ‘1’ indicates that the associated STC sequence is virtually deleted. In this case the STC sequence information ‘STC_Seq #i’ has an additional field ‘VD_SN #i’ for storing the virtually deleted sub-view stream number. There may be multiple fields of ‘VD_SN’ because intervals of more than one sub-view stream may be requested to be deleted. Also, a stream packet ID (PID) might be used instead of sub-view stream number.

When reproducing STC sequences, the optical disk apparatus examines the value of VD_Flag of a STC sequence. If it is set to ‘0’, the optical disk apparatus reproduces all the sub-view streams contained in the multi-view stream, otherwise the optical disk apparatus skips sub-view streams corresponding to virtually deleted sub-view streams by examining the fields ‘VD_SN’.

If the user requests retrieval of a virtual deleted sequence, the optical disk apparatus simply resets the corresponding VD_Flag (STC-Seq #2 in FIG. 6) to ‘0’, or deletes the information about the virtual deleted sequence, creates information about a new sequence including the sequences before and after the virtual deleted sequence (STC-Seq #1 and #3 in FIG. 6) and the virtual deleted sequence (STC-Seq #2 in FIG. 6), and updates the information about the sequence before the retrieved sequence (STC-Seq #1 in FIG. 6) using the created information. In the latter case, the information about the sequence after the retrieved sequence (STC-Seq #3 in FIG. 6) is also deleted from the clip management information.

The method for editing a multi-view stream in an optical disk apparatus in accordance with the invention enables separate editing of sub-view streams contained in a multi-view stream and easy retrieval of deleted intervals.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method for editing a multi-view stream in an optical disk apparatus, comprising the steps of:
(a) receiving a request to delete an interval of a sub-view stream contained in a recorded multi-view stream; and
(b) creating position information about the interval requested to be deleted and identification information about the sub-view stream, and recording the position information and identification information in the management information for the multi-view stream.

2. The method of claim 1, wherein said step (b) does not actually delete the data corresponding to the interval requested to be deleted.

3. The method of claim 1, wherein said position information contains information about the start and end positions of the interval requested to be deleted.

4. The method of claim 3, wherein the information about the sequence of the recorded multi-view stream is not modified by said deletion request.

5. The method of claim 3, wherein if a request to restore the interval requested to be deleted occurs, the information recorded in said step (b) is deleted from the management information.

6. The method of claim 1, wherein a sequence information field contained in the management information for the multi-view stream includes an information field indicating whether the corresponding sequence is virtually deleted.

7. The method of claim 6, wherein said position information contains information about the start and end positions of the interval requested to be deleted.

8. The method of claim 6, wherein the recorded multi-view stream sequence is divided into more than two sequences by said deletion request and said sequence information is updated and new sequence information is created accordingly.

9. The method of claim 6, wherein said interval requested to be deleted is managed as a recorded single sequence in the management information in the same way as said recorded multi-view stream is managed.

10. The method of claim 6, wherein if a request for retrieving the interval requested to be deleted occurs, the information field contained in the sequence information about the interval requested to be deleted is reset to the value before the virtual deletion, the information field indicating whether the corresponding sequence is virtually deleted.

11. The method of claim 6, wherein if a request to restore the interval requested to be deleted occurs, the information recorded in said step (b) is deleted from the management information and the information about the sequences before and after the interval is merged.

12. The method of claim 1, wherein if the intervals of multiple sub-view streams are requested to be deleted, plural pieces of identification information are created and recorded.

13. The method of claim 1, wherein the identification information about the sub-view stream is the number of the sub-view stream.

14. The method of claim 1, wherein the identification information about the sub-view stream is the packet ID of the sub-view stream.
